(19) United States
(12) Patent Application Publication
(10) Pub. No.: US 2016/0001591 A1
(43) Pub. Date: Jan. 7, 2016

(54) VEHICLE WHEEL DECORATION METHOD APPLYING DECORATION TO THREE-DIMENSIONALLY-SHAPED WHEEL DESIGN SURFACE, AND VEHICLE WHEEL WITH DECORATED THREE-DIMENSIONALLY-SHAPED WHEEL DESIGN SURFACE

(71) Applicant: RAYS ENGINEERING CO., LTD., Osaka (JP)

(72) Inventors: Shujiro Inatani, Osaka (JP); Kazunori Ito, Osaka (JP); Tsutomu Hiromasa, Osaka (JP); Tomoyuki Murakami, Osaka (JP)

(21) Appl. No.: 14/745,573

(22) Filed: Jun. 22, 2015

(30) Foreign Application Priority Data
Jul. 3, 2014 (JP) 2014-137723
Jul. 3, 2014 (JP) 2014-137724

(51) Int. Cl. B60B 1/06; B60B 3/10; B05D 5/06; B05D 1/36; B05D 3/02

(52) U.S. Cl. CPC B60B 1/06; B05D 1/36; B05D 3/0254; B05D 5/06; B60B 3/10; B60B 2900/572; B60B 2310/656

(57) ABSTRACT

A vehicle wheel decoration method for decorating a three-dimensionally-shaped wheel design surface of a vehicle wheel provided with a rim and a disk having a plurality of spokes, the wheel design surface being visible from the outside in a state where the vehicle wheel is mounted on a vehicle.

Causing a dispenser to move in respective directions of three axes or five axes along and relative to the wheel design surface in accordance with an NC program; and discharging and applying a solvent paint to the wheel design surface while controlling both a feed speed and a paint discharge amount, to form a decorative layer on the wheel design surface.

### BACKGROUND OF THE INVENTION

1. Field of the Invention

The present invention relates to a vehicle wheel decoration method by which a variety of decoration can be easily applied to a three-dimensionally-shaped wheel design surface of a vehicle wheel, and a vehicle wheel.

2. Description of the Related Art

Conventionally, in decorating a wheel design surface of a vehicle wheel, there has been adopted several means including means where a line pattern is formed by circumferentially laminating a tape to a surface of a front rim flange (Japanese registered utility model publication No. 3149592) and means where a pattern is transferred to a disk surface using a transfer seal (Japanese registered utility model publication No. 3037659).

However, in such conventional means, it is difficult to laminate a tape or a transfer seal to a three-dimensional composite curved surface such as a three-dimensionally-shaped wheel design surface in accordance with designed sizes without forming wrinkles or without causing positional displacement, which exhibits poor operability. For example, it is extremely difficult to apply a precision design formed of fine stripes to a three-dimensional composite curved surface. Further, it is necessary to prepare a tape or a transfer seal in advance and hence, design variations are also limited. Further, a tape, a transferred object, or the like laminated to a wheel design surface is liable to be peeled off by a scattered pebble or the like during traveling of a vehicle and hence, there has been a demand for the realization of a decoration which exhibits favorable fixing property.

Further, conventionally, as a method of painting a wheel design surface of a vehicle wheel in different colors, there has been adopted a method where the wheel design surface is painted in two or more colors by masking. There has been also adopted a method where base member metal is exposed by applying cutting to a portion of a side surface of a spoke painted with first color and, thereafter, a color clear paint of the second color is applied to the whole surface of a wheel so that the first color appears substantially as it is in the painted portion of the first color, and the second color appears in a metal exposed portion (JP-A-2010-158981).

However, it is difficult for painting in different colors by masking to apply a decoration to a three-dimensional curved surface of a three-dimensionally-shaped wheel design surface in different colors as designed. Further, it is necessary to prepare a masking jig which conforms to a curved surface of the wheel design surface, and mounting and removing steps of the masking jig, cleaning of the masking jig and the like also take time and effort and hence, it is difficult to efficiently perform painting. Still further, it is necessary to prepare masking in advance and hence, design variation is also limited.

In the method described in JP-A-2010-158981, it is necessary to perform cutting and hence, time and effort for cutting become necessary. Further, a color tone is determined based on the combination of a metal exposed surface, first color and second color and hence, unless thick color, particularly color which contains black as a base color is used as first color, the color tone of the first color is also changed whereby the combination of colors is limited in determining the color tone. Further, a corrosion resistant painting which constitutes a background layer is also lost by cutting. In such a cut portion, a paint layer is small compared to a non-cut portion, and cracks may occur in a painted film on a painting present/absent boundary at the time of cutting and hence, the method is disadvantageous in terms of corrosion resistance performance whereby there is a possibility that the protection performance of painting becomes insufficient.

On the other hand, in performing coloring by masking or cutting, it is extremely difficult to apply a precision decoration formed of fine stripes, for example.

### SUMMARY OF THE INVENTION

It is an object of the present invention to provide means which can easily apply a decoration to a three-dimensionally-shaped wheel design surface of a vehicle wheel with favorable fixing property.

It is another object of the present invention to provide means which can easily apply a design of multiple design variation to a three-dimensionally-shaped wheel design surface of a vehicle wheel.

It is still another object of the present invention to provide means which can easily form a decorative portion having a color which differs from a base color to a three-dimensionally-shaped wheel design surface of a vehicle wheel with a small number of steps without performing masking and cutting.

According to one aspect of the present invention, there is provided a vehicle wheel decoration method for decorating a three-dimensionally-shaped wheel design surface of a vehicle wheel provided with a rim and a disk having a plurality of spokes, the wheel design surface being visible from the outside in a state where the vehicle wheel is mounted on a vehicle, the method including:

causing a dispenser to move in respective directions of three axes or five axes along and relative to the wheel design surface in accordance with an NC program; and discharging and applying a solvent paint to the wheel design surface while controlling both a feed speed and a paint discharge amount of the dispenser, to form a decorative layer on the wheel design surface.

Due to the above-mentioned constitution, the solvent paint is discharged and applied to the wheel design surface using the dispenser while controlling both the feed speed and the paint discharge amount, and hence the decorative layer can be easily formed on the three-dimensionally-shaped wheel design surface and, for example, a fine decorative layer formed of stripes can be also easily formed. By moving the dispenser in the respective directions of three axes or five axes in accordance with an NC program, even when the vehicle wheel has a wheel design surface formed of a composite curved surface, the decorative layer can be formed exactly in accordance with designed sizes. Further, it is also possible to apply the decorative layer having a design allowing high degree of freedom and hence, the method can easily cope with designs of versatile design variation. Still further, when a decorative layer of the second color is formed on a portion of a base color layer of the first color by the dispenser, due to the use of the dispenser, a solvent paint which is the same kind of a paint of the first color can be used as a paint of the second color and hence, it is possible to form the decorative layer having favorable fixing property on the base color layer due to mutual bonding of the solvent paints.

According to another aspect of the present invention, there is provided a vehicle wheel decoration method for decorating a three-dimensionally-shaped wheel design surface of a vehicle wheel provided with a rim and a disk having a plurality of spokes, the wheel design surface being visible from the outside in a state where the vehicle wheel is mounted on a vehicle, the method including:

subjecting the wheel design surface to background layer painting for both corrosion resistance and leveling;

applying a solvent paint of a first color to the whole wheel design surface, to form a base color layer of the first color;

drawing a predetermined design on a portion of the base color layer by discharging and applying a solvent paint of a second color which differs from the first color to the portion of the base color layer in a form of dots, stripes or within a fixed range, to form a decorative layer of the second color;

forming a topcoat layer by applying a clear paint to the base color layer and the decorative layer; and

painting the wheel design surface in a plurality of colors by the base color layer and the decorative layer.

Due to the above-mentioned constitution, the decorative layer of the second color can be drawn by discharging and applying the solvent paint of the second color and hence, a decorative portion can be easily formed on the three-dimensionally-shaped wheel design surface with the small number of steps without performing masking and cutting. Further, by forming the decorative layer by drawing, even when the vehicle wheel has a wheel design surface formed of a three-dimensional composite curved surface, the decorative portion can be easily formed exactly in accordance with designed sizes. Further, it is also possible to apply the decorative portion having a design allowing high degree of freedom and hence, the method can easily cope with designs of versatile design variation. For example, a fine decorative portion formed of stripes can be easily formed.

According to still another aspect of the present invention, there is provided a vehicle wheel including:

a rim;

a disk having a plurality of spokes;

a decorated three-dimensionally-shaped wheel design surface visible from the outside in a state where the vehicle wheel is mounted on a vehicle;

a base color layer of a first color formed by applying a solvent paint of the first color to the whole wheel design surface; and

a decorative layer of a second color formed on a portion of the base color layer and drawn by discharging and applying a solvent paint of the second color which differs from the first color on the portion of the base color layer, wherein

the wheel design surface is painted in a plurality of colors by the base color layer and the decorative layer.

### BRIEF DESCRIPTION OF THE DRAWINGS

FIG. 1 is a front view showing an external appearance of a vehicle wheel according to an embodiment 1;

FIG. 2 is a cross-sectional view taken along a line II-II in FIG. 1;

FIG. 3A to FIG. 3C are schematic views showing steps of forming a painted film on a wheel design surface;

FIG. 4 is a schematic view showing one example of a decorative layer on a spoke top surface which is formed by combining dots and stripes;

FIG. 5 is a front view showing an external appearance of a vehicle wheel according to an embodiment 2;

FIG. 6 is a cross-sectional view taken along a line II-II in FIG. 5;

FIG. 7 is a schematic view showing the constitution of a dispenser used for forming a decorative layer of the second color;

FIG. 8A to FIG. 8D are schematic views showing steps of forming a painted film on a wheel design surface; and

FIG. 9 is a schematic view showing one example of a decorative layer formed on a spoke top surface which is formed of fine stripes.

### DETAILED DESCRIPTION OF THE PREFERRED EMBODIMENT

In embodiments described hereinafter, the present invention is applied to a vehicle wheel made of a light alloy and formed by forging or spinning. However, the present invention is not limited to such a vehicle wheel, and is also applicable to various kinds of vehicle wheels regardless of manufacturing methods and materials. The present invention is applicable also to both a wheel having the structure where a rim and a disk are formed into an integral body and a wheel having the structure where a rim and a disk are formed as members separate from each other.

### Embodiment 1

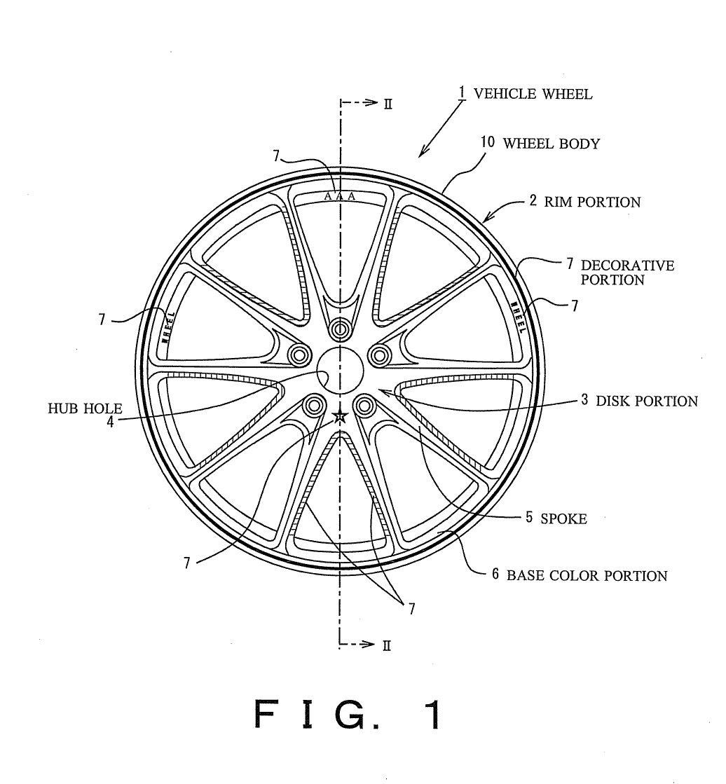

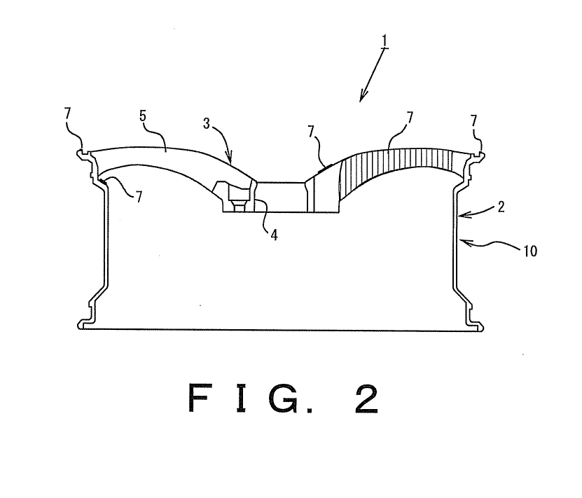

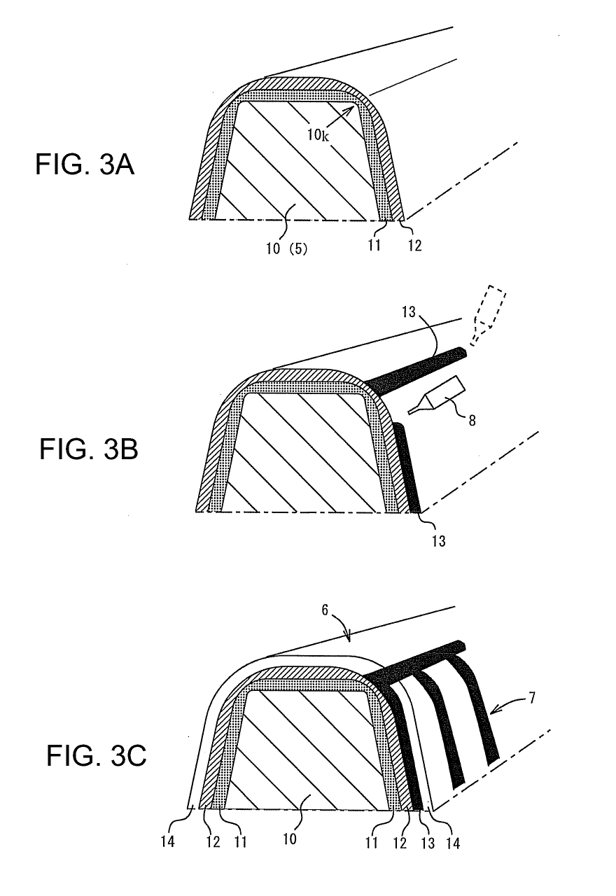

A vehicle wheel 1 shown in FIG. 1 and FIG. 2 is made of a light alloy, for example, an aluminum alloy. The vehicle wheel 1 is constituted of a disk portion 3 and a rim portion 2. The disk portion 3 has a hub hole 4 into which a hub of a vehicle can be fitted, and a plurality of spokes 5 which radially extend in the direction toward the outer periphery of the disk portion 3 from the hub hole 4. A wheel design surface of the vehicle wheel 1 has a base color portion 6 with a base tone color and a decorative portion 7 with a color other than the base color so that the wheel design surface is painted in multiple colors. The wheel design surface is formed of a surface of the rim portion 2 and a surface of the disk portion 3 which are visible from the outside in a state where the vehicle wheel 1 is mounted on the vehicle. The wheel design surface also includes top surfaces and side surfaces of the spokes 5. The wheel design surface has a three-dimensional shape. Examples of the wheel design surface include a three-dimensional curved surface such as a rounded R shape, a non-rounded angular shape, a projecting shape, and a recessed shape. As shown in FIG. 3C, as a painted film constitution on the wheel design surface, the base color portion 6 includes a primer layer 11, a base color layer 12, and a topcoat layer 14, and the decorative portion 7 includes a decorative layer 13 formed between the base color layer 12 and the topcoat layer 14 of the base color portion 6. These painted films are formed by applying solvent paints corresponding to painting purposes of the respective films. In general, a baking paint is favorably used as a solvent paint.

The painted film constitution is formed as follows. Before these painted films are formed on the wheel, a chemical conversion treatment such as alkali degreasing or a chromate treatment is applied to the whole surface of a wheel body 10 made of a metal material as a pretreatment for enhancing a corrosion resistance property. After the chemical conversion treatment is finished, the wheel body 10 is washed with water and is dried.

Thereafter, the primer layer 11 is formed by applying a primer paint to the whole surface of the wheel body 10 for enhancing corrosion resistant and leveling. The base color layer 12 of the first color is formed by applying a solvent paint of the first color, for example, a solvent paint of white or black to the primer layer 11 (see FIG. 3A). The first color becomes the base color which is a base tone color of the wheel design surface of the vehicle wheel 1. As the solvent paint of the first color, various kinds of solvent resin paints each of which contains a pigment forming the first color can be used. As the first color, any color can be selected from various kinds of colors such as red, blue, yellow, and green besides the above-mentioned white and black.

The decorative layer 13 of the second color is formed by discharging and applying a solvent paint of the second color which differs from the first color to a portion of the base color layer 12 of the first color, (see FIG. 3B). The decorative layer 13 of the second color can be formed at a desired position or within a desired range on the whole three-dimensional curved surface of the wheel design surface such as a surface of a flange of the rim portion 2 or a surface of the disk portion 3 including a top surface and a side surface of the spoke 5. Accordingly, the decorative layer 13 forms a decorative portion 7 which is painted in a color different from a color of the base color portion 6 on the three-dimensional curved surface of the wheel design surface thus exhibiting a decorative effect. FIG. 3A to FIG. 3C show an example where the decorative layer 13 of the second color is formed on the side surface of the spoke 5. As a solvent paint of the second color, various kinds of solvent resin paint each of which contains a pigment forming the second color can be used. Although various colors such as white, black, red, blue, yellow, or green can be used as the second color, a color which differs from the first color is selected. As the second color, it is preferable to select a color which minimally causes color mixing with the first color. By allowing the solvent resin paint of the second color to contain a desired color former, it is possible to make the second color stand out against the first color which is the base tone color.

Thereafter, the topcoat layer 14 is formed as an uppermost layer by applying a clear paint to the base color layer 12 and the decorative layer 13 from above (see FIG. 3C). Due to the formation of the topcoat layer 14, not only a weather resistance of the base color portion 6 can be enhanced but also a weather resistance of the decorative portion 7 can be enhanced. A solvent resin paint may be used as the clear paint. It is preferable to use a colorless clear paint so as not to change a color tone of the base color layer 12 (first color) and a color tone of the decorative layer 13 (second color). However, the color tone of the base color layer 12 (first color) and the color tone of the decorative layer 13 (second color) may be changed by using a colored clear paint. In the case of performing delustering, a delustering clear paint can be used.

A colorless clear paint or a colored clear paint may be applied to the base color layer 12 before the decorative layer 13 is formed on the base color layer 12. In this case, a weather resistance of the base color layer 12 can be further enhanced.

Next, a method of forming the decorative layer 13 is described.

The decorative layer 13 of the second color is formed on a portion of the base color layer 12 of the first color by drawing such that a solvent paint of the second color is discharged and applied to the portion of the base color layer 12 in the form of dots, stripes or within a fixed range. As means for discharging and applying the solvent paint, for example, it is possible to use discharging and applying means such as a dispenser nozzle, an inkjet head or a piece gun which can discharge a solvent paint with directivity thus applying the solvent paint in the form of stripes or dots. For example, when a dispenser is used, the decorative layer 13 is formed on the base color layer 12 formed on a three-dimensional curved surface of the wheel design surface by drawing such that the solvent paint is discharged and applied to the base color layer 12 while moving the dispenser nozzle in the respective directions of three axes or five axes in accordance with an NC program.

In the conventional masking or cutting, it has been difficult to decorate a three-dimensional curved surface of the wheel design surface having a three-dimensional shape by painting the three-dimensional curved surface in different colors. However, since the decorative portion 7 is drawn by discharging and applying a solvent paint of the second color in this manner, the beautiful decorative portion 7 can be easily formed on the whole three-dimensional curved surface of the wheel design surface. Accordingly, although it has been conventionally difficult to beautifully laminate a decorative portion to a composite curved surface of the wheel design surface by a decal or the like due to the formation of wrinkles or the like, the beautiful decorative portion 7 can be formed even on such a composite curved surface in accordance with designed sizes by the method of the present invention. Further, it is possible to apply the decorative portion 7 having a design allowing high degree of freedom to the wheel design surface and hence, the method can easily cope with designs of versatile design variation. Further, cutting is not performed and hence, there is no possibility that the number of man-hours is increased. There is also no possibility that corrosion resistance property is lowered due to a loss of a corrosion resistant painting of a background layer. The base color layer 12 and the decorative layer 13 are bonded to each other by mutual bonding between the solvent resin paints and hence, the decorative portion 7 which exhibits the excellent adhesiveness between the base color layer 12 and the decorative layer 13 thus having favorable fixing property can be formed on the three-dimensional curved surface of the wheel design surface. A clear paint which is used for forming the topcoat layer 14 is also a solvent resin paint and hence, due to the bonding between the solvent resin paints, excellent adhesiveness can be acquired between the topcoat layer 14 and the base color layer 12 and between the topcoat layer 14 and the decorative layer 13, whereby the topcoat layer 14 exhibits excellent protection property and durability. In these cases, it is preferable that main components which the solvent resin paints for forming the base color layer 12, the decorative layer 13, and the topcoat layer 14 respectively contain are resins of the same kind. The respective layers 12, 13, 14 can be formed by wet-on-wet painting so that bonding of the layers 12, 13, 14 can be further strengthened by drying by baking.

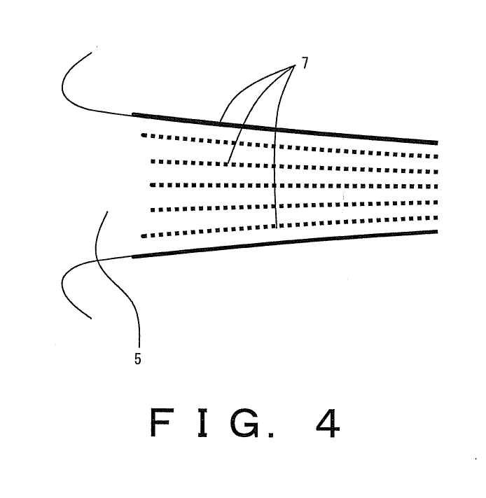

The decorative layer 13 is formed by discharging and applying a solvent paint of the second color such that the solvent paint draws stripes or dots. Accordingly, the decorative portion 7 which is formed of fine stripes or fine dots and is difficult to be formed by masking or cutting can be easily formed over the whole three-dimensional curved surface of the wheel design surface. For example, as shown in FIG. 4, even the decorative portion 7 in the form of dots or stripes can be easily formed on the top surface of the spoke 5 along a radial direction. Further, by discharging and applying a solvent paint of the second color within a fixed range, the matted decorative portion 7 can be also easily formed.

In this manner, the solvent paint can be discharged and applied in the form of dots or stripes or within a fixed range. Accordingly, various types of decorative portions 7 which can be expressed by drawing such as a logo, a letter, a symbol, a pattern, or a motif, a matted decorative portion 7, or decorative portions 7 in other various modes can be formed and hence, the three-dimensional curved surface of the wheel design surface can be easily painted in a variety of paintings. Further, a use amount of solvent paint of the second color can be reduced to a required minimum so that the excessive use of paint can be suppressed. Accordingly, it is possible to realize painting excellent in terms of cost and a working environment.

With respect to the solvent paint of the second color, the second color is not limited to a single color. Solvent paints of different colors are provided in a color exchangeable manner, and in a step of forming the decorative layer 13, the decorative layer 13 is drawn by discharging and applying the solvent paints of a plurality of respective colors. Accordingly, the decorative portion 7 which is the combination of a plurality of colors can be also easily formed and hence, a decorative effect of the wheel design surface can be further enhanced by the decorative portion 7 having variety of color variations. As a result, the decorative portion 7 having a design allowing high degree of freedom can be formed on the rim portion 2 and the disk portion 3 which form the three-dimensionally-shaped wheel design surface at desired positions and within a desired range not only in a single color but also in multiple colors.

The decorative portion 7 can be drawn by discharging and applying a solvent paint of the second color having high viscosity. By using the solvent paint having high viscosity, a pool of paint, sagging of liquid, parting of paint or the like can be suppressed. Accordingly, even when a solvent paint of the second color is discharged and applied to an inclined surface or a curved surface of the wheel design surface having a three-dimensional shape or the like, a paint neither sags nor forms a pool and hence, it is possible to realize painting having excellent paint retention property. Further, a film having a large film thickness can be formed by performing painting one time and hence, the number of times of overlapping coatings can be suppressed to a required minimum. Accordingly, a painting operation of a solvent paint of the second color can be performed efficiently.

The decorative layer 13 and the topcoat layer 14 are formed by wet-on-wet painting, and these formed layers are dried by baking as a final step. Due to such a method, the decorative layer 13 formed by discharging and applying the solvent paint is dried by baking in a state where the decorative layer 13 is covered with the topcoat layer 14 and hence, the deformation or the like of the drawn decorative layer 13 due to drying by baking can be suppressed. Further, painting steps can be efficiently performed in a simplified manner. The formation of the primer layer 11 to the topcoat layer 14, or the formation of the base color layer 12 to the topcoat layer 14 may be performed by wet-on-wet painting and then dried by baking.

Further, there is a tendency for a thickness of a painted film such as the primer layer 11 or the base color layer 12 to be decreased at a corner portion 10k such as an edge or a ridge on the wheel design surface, for example, a boundary between a top surface and a side surface of the spoke 5 or a projecting corner of a stepped portion of the rim portion 2 (see FIG. 3A). Accordingly, by forming the decorative layer 13 on the corner portion 10k by discharging and applying a solvent paint of the second color to the corner portion 10k, a thickness of the paint at the corner portion 10k can be increased (see FIG. 3C) and hence, corrosion resistance property and protection property at the corner portion 10k can be enhanced.

### Embodiment 2

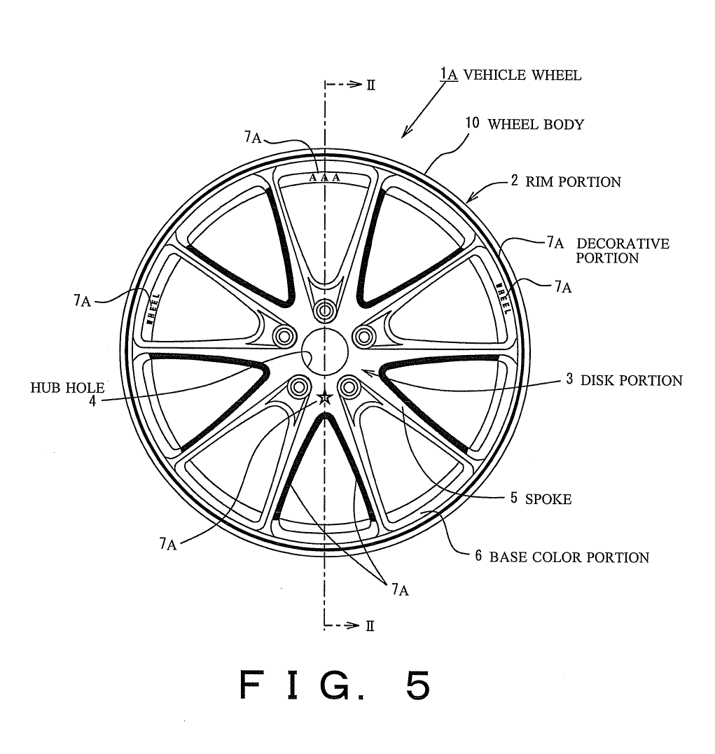

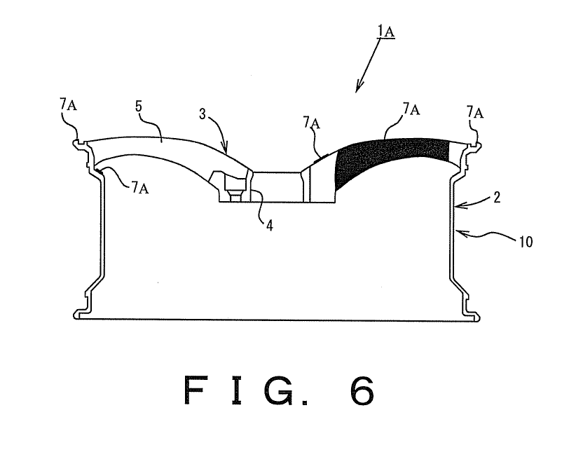

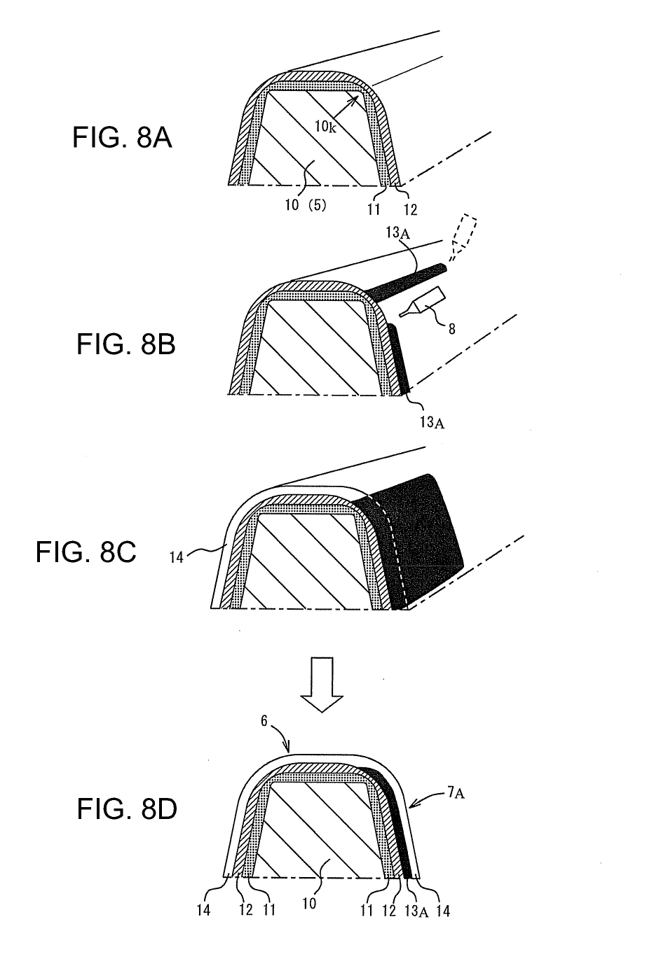

As shown in FIG. 5 and FIG. 6, in the same manner as the embodiment 1, a wheel design surface of a vehicle wheel 1A of an embodiment 2 is painted in multiple different colors such that the wheel design surface has a base color portion 6 of a base tone color and a decorative portion 7A of a color other than the base color. As shown in FIG. 8D, a painted film on the wheel design surface includes, in the base color portion 6, a primer layer 11, a base color layer 12, and a topcoat layer 14, and includes, in the decorative portion 7A, a decorative layer 13A formed between the base color layer 12 and the topcoat layer 14 of the base color portion 6. In the vehicle wheel 1 shown in FIG. 1, the decoration of a side surface of a spoke is performed such that the decorative layer 13 is formed in stripes (FIG. 2 and FIG. 3C). On the other hand, in the vehicle wheel 1A shown in FIG. 5, a decorative layer 13A is formed in a planar shape (FIG. 6 and FIG. 8C). As shown in FIG. 8A, FIG. 8B, and FIG. 8C, the painted film having the above-mentioned constitution is formed by sequentially forming the primer layer 11, the base color layer 12, the decorative layer 13A, and the topcoat layer 14 on a wheel body 10 to which a pretreatment is applied. In the embodiment 2, the structure, a material, and a painted film of the vehicle wheel 1A are exactly the same as those described in the embodiment 1.

Next, a method of forming the decorative layer 13A is described.

In the embodiment 2, the decorative layer 13A of the second color is formed on a portion of the base color layer 12 of the first color by drawing such that a solvent paint of the second color is discharged and applied to a portion of the base color layer 12 using a dispenser 8.

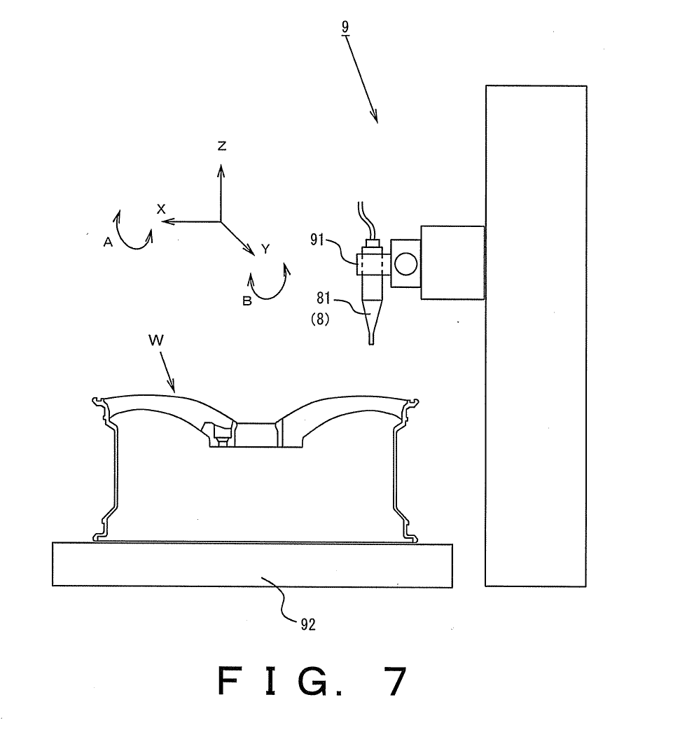

For example, the dispenser 8 can be used in a state where the dispenser 8 is mounted on a working machine 9 used in a finishing operation of the wheel body 10 or the like. As shown in FIG. 7, by replacing a cutting tool (not shown in the drawing) mounted on a tool holder 91 with a dispenser nozzle 81, the working machine 9 can be used as the dispenser 8. As the working machine 9, a working machine can be used where the dispenser nozzle 81 is movable in three axes consisting of an axis in the longitudinal direction (X axis), an axis in the left-and-right direction (Y axis), and an axis in the up-and-down direction (Z axis). Alternatively, as the working machine 9, a working machine is used where the dispenser nozzle 81 is movable in five axes further consisting of turning about an X axis (A turning) and turning about a Y axis (B turning) in addition to the above-mentioned three axes. The movement in three axes or in five axes is not limited to the movement of only the dispenser nozzle 81. The movement in three axes or in five axes is not limited to only the movement of the dispenser nozzle 81 and may be realized as the combination of the movement of the dispenser nozzle 81 and the movement of a worktable 92 to which the wheel body 10 constituting a workpiece W is fixed. Using the working machine 9 on which the dispenser nozzle 81 is mounted, the decorative layer 13 of the second color is formed on a coating surface of the workpiece W (the wheel body 10 on which the base color layer 12 is already formed) as follows. That is, the decorative layer 13 of the second color is formed on the coating surface by drawing by discharging and applying a solvent paint of the second color to the coating surface while controlling the movement of the dispenser nozzle 81 and a painting range and maintaining a fixed clearance between the coating surface of the workpiece and the dispenser nozzle 81 by moving the dispenser nozzle 81 in three axes or five axes in accordance with an NC program.

The dispenser 8 is configured to be mounted on the working machine 9 in this embodiment. However, the dispenser 8 may be configured to be movable three dimensionally in accordance with an NC program by an articulated robot, a machine provided with multiple-axis arms or the like.

In this manner, since the decorative portion 7A is drawn by discharging and applying a solvent paint of the second color using the dispenser 8, compared to the case where the decorative portion 7A is formed by performing the decoration using a tape, a transfer seal, a decal or the like, the decorative portion 7A can be easily formed on a three-dimensional curved surface of a wheel design surface. By moving the dispenser 8 in the respective directions of three axes or five axes in accordance with an NC program, the beautiful decorative portion 7A can be formed in accordance with designed sizes even on a composite curved surface of the wheel design surface to which a decorative portion has not been conventionally beautifully laminated using a decal or the like due to the formation of wrinkles or the like. Also compared to the case where a decorative portion 7A is formed by performing the decoration such that a wheel design surface is painted in different colors by masking or cutting, the beautiful decorative portion 7A can be easily formed. Further, the decorative portion 7A having a design allowing high degree of freedom can be applied to the wheel design surface and hence, the method can easily cope with designs of versatile design variation.

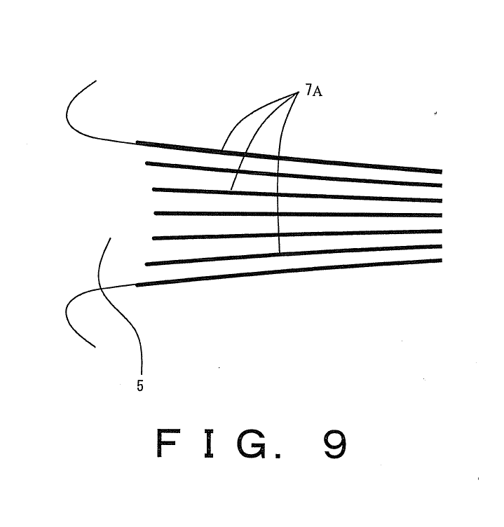

The dispenser 8 forms the decorative portion 7A by drawing by discharging and applying a solvent paint of the second color after suitably setting a diameter of a nozzle of the dispenser nozzle 81, a clearance between the dispenser nozzle 81 and the painting surface, a discharge amount of solvent paint, coordinate data of the NC program, and the like. By forming the decorative portion 7A by discharging and applying the solvent paint of the second color using the dispenser 8 in such a manner that stripes or dots are drawn by the solvent paint of the second color, the fine decorative portion 7A formed of stripes or dots can be also easily formed on the whole three-dimensional curved surface of the wheel design surface. For example, as shown in FIG. 9, a plurality of stripe-like decorative portions 7A which extend along the radial direction can be also easily formed on a top surface of a spoke 5. Further, by discharging and applying the solvent paint of the second color within a fixed range by the dispenser 8, a matted decorative portion 7A can be also easily formed.

In this manner, by changing setting of operation of the dispenser 8, a solvent paint can be discharged and painted in the form of dots or stripes or within a fixed range and hence, various types of decorative portion 7A which can be expressed by drawing such as a logo, a letter, a symbol, a pattern, or a motif, a matted decorative portion 7A, or decorative portions 7A in other modes can be formed, whereby the three-dimensional curved surface of the wheel design surface can be easily painted in different colors. Further, a use amount of solvent paint of the second color can be reduced to a required minimum and hence, the excessive use of paint can be suppressed. Accordingly, painting excellent in a cost and a working environment can be realized.

The dispenser nozzle 81 may be configured to continuously discharge and apply a solvent paint of the second color. Alternatively, the dispenser nozzle 81 may be configured to intermittently discharge and apply a solvent paint by ejecting the solvent paint in a dotted manner. In the case where the dispenser nozzle 81 discharges and applies a solvent paint by ejecting the solvent paint in a dotted manner, even when a relatively large clearance (distance) is set between the dispenser nozzle 81 and the coating surface, the decorative portion 7A can be beautifully formed by drawing along a locus of the dispenser nozzle 81 without forming a pool of paint. Accordingly, by setting the clearance to a large clearance, the collision between the dispenser nozzle 81 and the workpiece W can be avoided with certainty and hence, a movable range of the dispenser nozzle 81 can be expanded. As a result, the decorative portions 7A of various modes can be easily formed by drawing. Further, the decorative portion 7A can be easily formed by drawing even on a complicated curved surface of the wheel design surface exactly in accordance with designed sizes. In both the continuous discharging of a solvent paint of the second color from the dispenser nozzle 81 and the intermittent discharging of a solvent paint of the second color from the dispenser nozzle 81, by controlling a feeding speed of the dispenser nozzle 81 or a discharge amount of paint, a thickness of color, a width of a line, and the like of the decorative layer 13A can be suitably set. Further, in both the continuous discharging of a solvent paint of the second color from the dispenser nozzle 81 and the intermittent discharging of a solvent paint of the second color from the dispenser nozzle 81, by reducing a discharge amount of paint along with the lowering of a moving speed of the dispenser nozzle 81, for example, a width of a corner portion of a drawn line can be set equal to a width of straight portion of the drawn line by preventing the increase in the width of the line.

The dispenser 8 is not limited to the constitution where a solvent paint of a single second color is discharged and painted from a single dispenser nozzle 81. That is, the dispenser 8 may be configured to perform a change in second color by using a plurality of dispenser nozzles 81 which discharge and apply solvent paints of different colors. Due to such a constitution, the decorative portion 7A which is formed by combining a plurality of colors can be also easily formed.

The dispenser 8 discharges and applies a solvent paint of the second color having high viscosity and hence, it is possible to suppress a pool of paint, sagging of a liquid, parting of a liquid, and the like.

By forming the decorative layer 13A on a corner portion 10k such as an edge or a ridge on a wheel design surface (see FIG. 8A) by discharging and applying a solvent paint of the second color using the dispenser 8, a thickness of a painted film at the corner portion 10k can be increased (see FIG. 8C) and hence, corrosion resistance property and protection property at the corner portion 10k can be enhanced.

Further, the manner of operation and advantageous effects described in the embodiment 1 can be acquired also by the embodiment 2 in the same manner.

The scope of the present invention is not limited to the above-mentioned embodiments, and can be expanded to a range equivalent to the scope of claims.

1. A vehicle wheel decoration method for decorating a three-dimensionally-shaped wheel design surface of a vehicle wheel provided with a rim and a disk having a plurality of spokes, the wheel design surface being visible from the outside in a state where the vehicle wheel is mounted on a vehicle, the method comprising:
causing a dispenser to move in respective directions of three axes or five axes along and relative to the wheel design surface in accordance with an NC program; and
discharging and applying a solvent paint to the wheel design surface while controlling both a feed speed and a paint discharge amount, to form a decorative layer on the wheel design surface.

2. The vehicle wheel decoration method according to claim 1, wherein
the dispenser discharges and applies a solvent paint by ejecting the solvent paint in a dotted manner.

3. The vehicle wheel decoration method according to claim 1, comprising
subjecting the wheel design surface to background layer painting for both corrosion resistance and leveling in advance;
applying a solvent paint of a first color to the whole wheel design surface, to form a base color layer of the first color; and
discharging and applying a solvent paint of a second color which differs from the first color to a portion of the base color layer by the dispenser, to form a decorative layer of the second color.

4. The vehicle wheel decoration method according to claim 1, wherein
a clear paint is applied to the decorative layer formed by the dispenser and, thereafter, the clear paint is dried by baking.

5. A vehicle wheel decoration method for decorating a three-dimensionally-shaped wheel design surface of a vehicle wheel provided with a rim and a disk having a plurality of spokes, the wheel design surface being visible from the outside in a state where the vehicle wheel is mounted on a vehicle, the method comprising:
subjecting the wheel design surface to background layer painting for both corrosion resistance and leveling;
applying a solvent paint of a first color to the whole wheel design surface, to form a base color layer of the first color;
drawing a predetermined design on a portion of the base color layer by discharging and applying a solvent paint of a second color which differs from the first color to the portion of the base color layer in the form of dots, stripes or within a fixed range, to form a decorative layer of the second color;
forming a topcoat layer by applying a clear paint to the base color layer and the decorative layer; and
painting the wheel design surface in a plurality of colors by the base color layer and the decorative layer.

6. A vehicle wheel comprising:
a rim;
a disk having a plurality of spokes;
a decorated three-dimensionally-shaped wheel design surface visible from the outside in a state where the vehicle wheel is mounted on a vehicle;
a base color layer of a first color formed by applying a solvent paint of the first color to the whole wheel design surface; and
a decorative layer of a second color formed on a portion of the base color layer and drawn by discharging and applying a solvent paint of the second color which differs from the first color on the portion of the base color layer, wherein
the wheel design surface is painted in a plurality of colors by the base color layer and the decorative layer.

7. The vehicle wheel according to claim 6, wherein
a predetermined design is formed by the decorative layer such that the decorative layer is formed by discharging and applying the solvent paint of the second color to draw a form of dots or stripes or within a fixed range.

8. The vehicle wheel according to claim 6, further comprising a topcoat layer formed above the base color layer and the decorative layer by applying a clear paint as an uppermost layer.
